(19) United States
(12) Patent Application Publication
(10) Pub. No.: US 2023/0125830 A1
(43) Pub. Date: Apr. 27, 2023

(54) USE OF IO EVENT METADATA TO ENABLE XAAS BILLING AND ANALYTICS

(71) Applicant: EMC IP Holding Company LLC, Hopkinton, MA (US)

(72) Inventors: Amy N. Seibel, Newton, MA (US); Joel Christner, El Dorado Hills, CA (US); Kenneth Durazzo, Morgan Hill, CA (US)

(21) Appl. No.: 17/451,782

(22) Filed: Oct. 21, 2021

(51) Int. Cl. G06Q 20/14; G06Q 20/10; G06Q 40/00; H04L 12/14

(52) U.S. Cl. CPC G06Q 20/145; G06Q 20/102; G06Q 40/12; H04L 12/1403

(57) ABSTRACT

One example method includes identifying an IO event comprising an IO made by a customer against a service hosted at an XaaS platform, and the IO event is associated with IO event metadata generated by the service, associating the IO event metadata with a billable customer operation, analyzing the IO event metadata and, based on the analyzing, associating the IO event with the customer, and generating a customer bill based on the associating of the IO event metadata with the billable customer operation, and based on the associating of the IO event with the customer.

### FIELD OF THE INVENTION

Embodiments of the present invention generally relate to IO (Input/Output) event metadata. More particularly, at least some embodiments of the invention relate to systems, hardware, software, computer-readable media, and methods for leveraging collected IO event metadata to enable mechanisms for billing and analysis while ensuring privacy is maintained where necessary.

### BACKGROUND

Various systems exist for billing consumers for data protection services, and computing services, for example. However, existing XaaS billing methods are not consistent in providing customers with granularity in terms of how they consume services. For instance, object billing and file billing are based on different usage measurements. XaaS platforms today, including cloud providers such as Amazon provide a roll-up of cost based on operation, but do not provide customers the ability to drill-down into the specific IO operations that comprised the cost category, nor do such providers allow customers to query the underlying data that comprised the cost category. Furthermore, providing the ability to view or query the underlying IO event metadata could create a security or privacy concern.

As well, it is difficult to bill customers for exactly what they use in a uniform manner across heterogeneous storage services, such as file and object level services for example. Furthermore, customers cannot currently get a granular, such as IO-level for example, look into the events that comprised the line items within the bill, nor can the customer query the underlying data. As a result, it is hard for a customer to validate a bill and understand exactly which users (identities), which applications (processes), and which systems consumed the service, where the systems consuming the resources are located, what hosted resources, such as files and objects for example, were used, how they were used, and what types of IO events, such as reads and writes, were issued against those resources.

Finally, given the ability to produce granular metadata around discrete or correlated IO events, exposing such information to a billing customer for analysis or enabling queries could expose sensitive data about the underlying data users. A mechanism would be needed to allow domain-specific, geography-specific, or regulatory-specific rules to govern which pieces of underlying IO metadata could be made visible to a customer analyzing the bill or querying the underlying data.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture according to some embodiments.

FIG. 2 discloses aspects of an example method according to some embodiments.

FIG. 3 discloses aspects of an example computing entity operable to perform any of the disclosed methods, processes, and operations.

### DETAILED DESCRIPTION OF SOME EXAMPLE EMBODIMENTS

Embodiments of the present invention generally relate to IO event metadata. More particularly, at least some embodiments of the invention relate to systems, hardware, software, computer-readable media, and methods for leveraging collected IO event metadata to enable mechanisms for billing and analysis while ensuring privacy is maintained where necessary.

In general, example embodiments of the invention may operate to collect IO event metadata and emit the IO event metadata to external entities, such as customers or other entities. Once the IO event metadata has been emitted and persisted in an external entity, queries may be run, such as by a customer or other party, over the IO event metadata to answer key questions around data and computing usage. Embodiments of the invention may operate to externalize IO event metadata to enable “as a Service” billing, such as at an IO level of granularity. More particularly, example embodiments may use IO event metadata in a variety of ways, including billing processes, that may be useful to a service provider and/or a consumer of services provided by the service provider.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that event metadata may be obtained at relatively granular individual IO level, rather than at a higher level, such as a file or object level, and the IO event metadata may be used to support various customer and vendor processes. An embodiment of the invention may provide a customer the ability to determine, at an IO event level, a basis for a bill received by the customer. An embodiment may enable a customer to protect sensitive information, while still enabling the customer to gain insights, at an IO event level, about processes involving the customer and the services which the customer consumes. An embodiment may better enable a service provider to ensure an accurate accounting of services provided to a customer. Various other advantages of example embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of Some Example Operating Environments

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, among other things, data storage and recovery operations, and computing operations. As such, at least some embodiments of the invention may be implemented in connection with various data storage and protection platforms, and computing platforms, that are implemented in a cloud computing environment.

For example, cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

Note that as used herein, the term ‘data’ is intended to be broad in scope. Thus, that term embraces, by way of example and not limitation, data segments, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

### B. Overview

Briefly, example embodiments may leverage IO event metadata to provide a foundation for enabling XaaS billing mechanisms, customer-viewable usage logs with analytics, and the ability to protect user privacy without compromising granularity or drill-down.

Example embodiments of the invention may operate in connection with IO event metadata that has been collected and provided to one or more entities. Processes for collecting IO event metadata are disclosed in U.S. Pat. Application, Ser. 17/446,531, entitled SYSTEM AND METHOD FOR CORRELATING FILESYSTEM EVENTS INTO MEANINGFUL BEHAVIORS, and filed Aug. 31, 2021, which is incorporated herein in its entirety by this reference.

After IO event metadata has been collected and emitted to one or more entities, queries can be run over the IO event metadata to answer various questions relating to data usage. To illustrate, example embodiments of the invention may employ IO event metadata to enable XaaS (X as a Service, where ‘X’ denotes one or more unspecified services) billing by implementing processes such as:
Use IO event metadata to dictate what is chargeable and what is not;
Use IO event metadata to only bill for actual usage;
Use IO event metadata as a basis for generating an invoice for a customer, either internal or external customer;
Use IO event metadata as a mechanism to enable a customer to drill-down to see exactly what IO(s) comprised, or formed the basis for, the line items on the customer bill; and
With external rules, sanitize IO event metadata to redact or remove certain elements such as, for example, IP address, employee ID, name, and email, to protect privacy and maintain compliance with data privacy standards, such as GDPR, CCPA, or company policies, for example, while a customer analyzes the underlying data to understand their bill and the basis for billing.

Further, and pursuant to privacy policies, agreements, and preferences, for example, an example schema for IO event metadata may include, but is not limited to IO event metadata such as:
General
   Timestamp, success indicator, type of event, result (success/failure), content length
Source Context
   The system from which the identity initiated the IO request that caused the event
   A GUID that does not easily trace back to a particular person or device (e.g. a randomly generated GUID instead of a username or email address) name, IP, hostname
Target Context
   A system GUID for the system hosting the requested resource and servicing the IO request (randomly generated)
   GUID, name, IP, hostname
   Extended:
      S3 request
      HTTP request
      HTTP response
Identity Context
   A GUID (that does not easily trace back to a particular person or device) for the requestor initiating an IO request from source to a resource on target
   GUID, name, group
   Extended:
      Tenant
      User
      Credential object
Resource Context
   The handle hosted on target that is being consumed by identity on source
   A GUID (that does not easily trace back to a particular person or device), name, container, object, URL
   Extended:
      Bucket (w/ ACLs, tags)
      Object (w/ ACLs, tags)

### B. Aspects of Some Example Embodiments

Example embodiments may be particularly relevant, and useful, to companies expanding their XaaS offerings, by enabling customers to pay for only what they use, as opposed to, for example, paying for capacity, such as storage or computing, that may not be needed, and thereby providing an opportunity for the company to differentiate itself. Further, companies may be able to provide unique value by giving customers the opportunity to better understand and analyze their service bill, and to drill-down to identify users, applications, systems, and data incident to their charges. This, in turn, may enable various opportunities for both the company when providing customers with an as-a-service offering, and the customers when providing their internal stakeholders with services to consume based on the company XaaS platforms.

In general, example embodiments may operate to leverage collected IO event metadata to enable various mechanisms for billing and analysis while ensuring privacy is maintained where necessary.

### B.1 Architecture

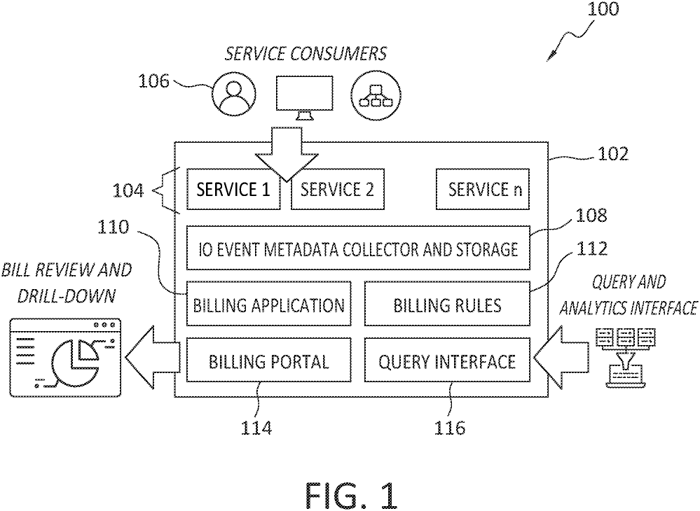

With reference now to FIG. 1, details are provided concerning an example architecture 100 according to some embodiments. As shown in FIG. 1, a vendor, such as a cloud service provider for example, may operate and maintain an XaaS platform 102 by way of which various services 104 may be provided to service consumers 106, who may also be referred to herein as service users. Such services may include, for example, data storage, data backup, and computing services. Operation of the services 104 may result in the generation of IO event metadata. Thus, the XaaS Platform 102 may also comprise IO event metadata collector and storage 108, or simply “IO event metadata collector.” In general the IO event metadata collector may operate to collect metadata concerning IO events, such as data reads and writes, for example, and may also operate to store the collected metadata. The IO events may be directed, for example, to objects, files, and other data or collections of data, examples of which are disclosed herein.

Various applications, which may relate to services provided to the consumers 106 by a vendor, may be hosted on the XaaS platform 102. Such applications may include, for example, a billing application 110, that may be associated with, or incorporate, one or more billing rules 112. As disclosed in more detail elsewhere herein, the billing application 110 may perform various operations based on the billing rules 112 and the IO event metadata that has been collected.

The XaaS platform 102 may also implement various features and functions related to billing. For example, the XaaS platform 102 may include a billing portal 114 by way of which a consumer of one of the services 104 may perform operations such as reviewing bills, and drilling down within a bill to obtain various information, such as the basis for a particular bill item. As well, the XaaS platform 102 may include a query interface 116, which may comprise a GUI (Graphical User Interface), or CLI (Command Line Interface). A consumer or service user may use the query interface 116 to perform various queries concerning IO event metadata relating to services consumed by the service user and for which the user has been billed, queries regarding services for which the consumer has been billed, and queries regarding vendor bills.

### B.2 Operations

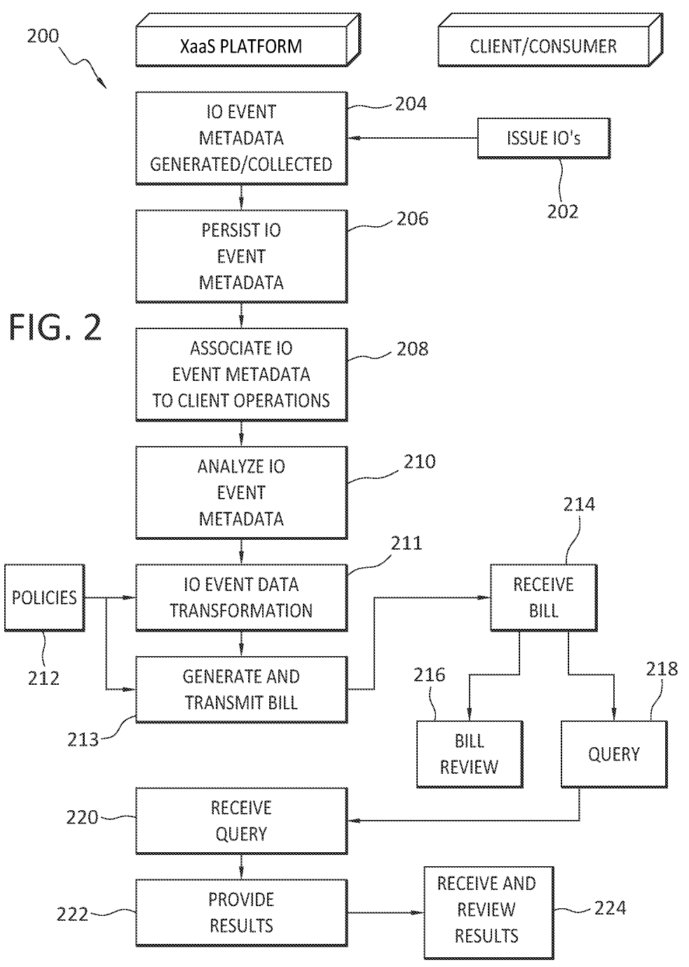

With continued reference to the example architecture 100 of FIG. 1, and directing attention as well to the example method 200 disclosed in FIG. 2, further details are provided concerning example operational aspects of some embodiments of the invention. A general description of some example embodiments will be provided, followed by a discussion of the example method 200.

Operations according to some embodiments may proceed as follows – note that not all the operations are necessarily performed in every embodiment, the order of operations may vary from one embodiment to another (for example, a service user may open a billing account before IO event metadata is generated concerning IOs issued by that service user):
Services 104 within an XaaS platform 102 generate IO event metadata and emit to a collector 108, which may persist the IO event metadata in a terminal storage repository (not shown) located at the XaaS platform 102, or elsewhere, that supports query functionality, such as, for example, relational databases, and graph databases.
Service users 106 may open a billing account on the as-a-service platform and perform requisite steps to establish the billing relationship as a service consumer.
The XaaS platform 102 may connect with requisite identity providers and other authoritative identity services (not shown) including LDAP (Lightweight Directory Access Protocol), Active Directory, DHCP (Dynamic Host Configuration Protocol), and DNS (Domain Name System).
The designated billing administrator at service user, or the XaaS service platform 102 administrator, may specify which pieces of IO event metadata should be available for drill-down or query.
A billable action, such as one or more IOs, may be performed by a user, application, or process, for example, against one or more services 104, such as Service 1 and Service 2 for example, in the XaaS platform 102. Such billable actions may include, but are not limited to, creating/reading/updating/deleting an object or other piece or group of data, and listing a bucket.
The service 104 in the XaaS platform 102 may generate and emit IO event metadata related to the billable action, and the IO event metadata may be collected and persisted (as noted above).
Periodically, such as monthly, or on a pre-determined or frequency negotiated with the user 106, the collected IO event metadata may be analyzed, such as by the billing application 110 using the billing rules 112, to generate a bill for the user - this may be done all at once as the bill is generated, or, rolling totals may be maintained throughout the billing period that are dynamically updated as each IO event occurs.
The billing application 110 may consult with external identity providers and other systems of record , as noted above, to associate IO events with identities, such as users or service accounts for example, and extract relevant identity metadata such as, for example, group membership (accounting, engineering, and others), and metadata annotations on the accounts.
When the bill is generated by the billing application 110, the billing rules 112 may be consulted to determine which pieces of IO event metadata should not be visible to the user should the user want to query the underlying data or otherwise view it. The user in this case may be, for example, a manager at the customer 106 company who wants to determine what the basis was for a bill received, but who is not authorized by the customer 106 company to view the personal data of customer company 106 employees who were involved in requesting/using the services for which the bill was generated.
Should a user query or otherwise request access to view, copy, or print, for example, the underlying data, and certain pieces need to be redacted or removed per the billing rules 112, various actions may be taken, for example:
   The billing application 110 may filter the data presented to the user in real-time; or
   The entirety of the IO event metadata may be duplicated, such as at/by the XaaS platform 102, and the sensitive information may be removed from the duplicate, and the duplicate with sensitive information removed may then be linked to the bill for access by the user 106. In some implementations, the sensitive IO event metadata may not be duplicated, thus eliminating the need to remove the sensitive information from a duplicate. In this example, the remaining IO event metadata, that is, IO event metadata that is not sensitive, may still be duplicated.
Example types of information that may require revocation or scrubbing include a user name, email address, contact information, or anything that could personally identify the user - in such cases, unique identifiers (such as a GUID or UUID) may be inserted into the record, replacing the sensitive information, to allow association of records without identifying the user.

### C. Example Methods

It is noted with respect to the example method 200 of FIG. 2 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Directing attention now to FIG. 2, the example method 200 may begin when a customer, such as a customer application for example, issues one or more IOs 202, such as a read, write, delete, copy, clone, or other IO, against a service and/or data of the service. The service may be hosted at an XaaS platform and provided to the customer. The service may receive 204 the IO from the customer and, in connection with the carrying out of the operations specified by the IO, generate and/or obtain IO event metadata. The IO event metadata may then be persisted 206 to storage, which may be local to the XaaS platform and/or elsewhere. The IO event metadata may then be associated 208 with one or more client/customer operations, that is, the operations that caused the IO to be issued 102 by the client.

At some point, the IO event data may be analyzed 210, such as by a billing application. The analyzing 210 may be performed on a regular recurring basis and/or on an ad hoc basis. The analyzing 210 may, or may not, be performed close in time to the issuance 202 of the IOs.

After the IO event data has been analyzed 210, and based on that analysis, an IO event data transformation process 211 may be performed with respect to the IO event data. In some embodiments, the transformation process 211 may involve removing, or omitting, IO event data, such as privacy data for example, from IO event data that is to be included in, or otherwise associated with, a bill. Policies 212 may dictate which information and data should be removed, or omitted, from IO event data prior to generation 213 of the bill.

In general, the content of a bill may depend, for example, on the application of privacy policies, privacy regulations, and/or any other applicable standards, rules, or laws. In some embodiments, the policies 212 and other controls may be defined, such as by an administrator for example, as part of the method 200, or separately from the method 200. The policies may be based, for example, on company policies concerning the handling of sensitive information. Further, some embodiments may provide for the importation, or other accessing of, applicable policies, such as those promulgated by a third party. To illustrate, an embodiment may import, or otherwise access, GDPR regulations that may then be used as a basis for the analysis 210.

The bill(s) may specify, for example, exactly which users (identities), which applications (processes), and which systems consumed the service against which the IOs were issued 202, where the systems consuming the resources are located, what hosted resources, such as files or objects for example, were used, how those hosted resources were used, and what types of IO events were issued against those resources.

The generation 213 of a bill may comprise, among other things, performance of one or more processes that ensure that the bill that is ultimately sent to the customer does not include sensitive information that the customer is not authorized to access. Examples of such processes are noted elsewhere herein and include removing sensitive IO event metadata from a metadata duplicate, and copying only non-sensitive IO event metadata so that there is no need to remove IO event metadata from a duplicate. The bill generation 213 may also comprise filtering, in real time, the data to be presented to the user. For example, sensitive data may be removed from a duplicate, or simply not duplicated, in real time.

In connection with the generation and transmission of a bill 213, one or more billing rules may identify IO event metadata that must be scrubbed from the bill before the bill is sent. In some embodiments, the customer may participate in definition of the billing rules so that the customer is able to specify, for example, which users at the customer may/may not have access to personal, or other confidential, information embodied in/by the IO event metadata. Thus, a bill issued 213 by the XaaS platform may have such persona/confidential information redacted.

The client/consumer may receive 214 the bill. Depending on the embodiment, the bill may be pushed to, or pulled by, the client/consumer. After the client has received 214 the bill, the client may take various actions with respect to the bill and information/metadata contained in the bill. For example, the client may review the bill 216 to determine, for example, which services of the XaaS were consumed by departments of the client, and an extent to which those services were consumed. This information is available to the client by virtue of the use of the IO event metadata which enables such a granular approach to determining the basis for a bill.

Another action that the client may take after receiving the bill, and/or which the client may take even if no bill has been received, is to perform a query 218. In general, the query 218 may be directed to any information, data, and/or metadata, concerning a service or services consumed by the client. A query may, or may not, relate to a bill received 214 by the client. For example, a client may wish to know, for a given time period, which services were consumed by users at the client, the amount of services consumed, and the identity of the departments that consumed the services. Some example use cases are disclosed elsewhere herein.

After the client has generated and transmitted the query 218, the query may be received 220 by the XaaS service platform. The XaaS service platform may retrieve information, data, and/or metadata, responsive to the query. The results may be filtered according to any applicable rules, such as billing rules that require redaction of confidential information for example, and then provided 222 to the client. The client may then receive 224 and review the results.

### D. Further Discussion

As will be apparent from this disclosure, example embodiments of the invention may possess various useful features and advantages. One of such features and advantages concerns the use of IO event metadata to generate as-a-service bills. Particularly, some embodiments may leverage IO event metadata to generate bills in XaaS environments, giving users the ability to understand their actual cost per IO with drill-down into specific events that caused the charge, or, query the IO event metadata to understand patterns. Embodiments may also enable a user interface to help the user visualize their bills and billing/usage patterns.

Another example of such features and advantages concerns provision of a user configuration to determine which IO event properties will be visible. In particular, example embodiments may enable the user/customer and/or service provider to define which IO event properties should be visible when personnel at the customer are examining underlying IO events that comprise a line item on the as-a-service bill, and, which should be redacted or removed. This functionality may help to ensure privacy and compliance concerns are addressed, while also retaining the ability to analyze workload patterns and query underlying IO events to understand usage.

In another example of features and advantages that may be implemented by some example embodiments, such example embodiments may provide for flexible and configurable billing. Particularly, example embodiments may enable the service provider, or another designated user, to configure the basis of billing. For example, billing may be determined and implemented on an operation basis (such as total number of object gets, total number of bytes read, for example), an operation rate basis (such as 1,000 IOPs sustained, for example), tiers based on operation rate ranges (such as 1001-5000 IOPs sustained, for example), and on a billing frequency basis (such as daily, weekly, monthly, for example). This is a superset of existing service billing models that introduces an operation rate basis and operation rate ranges for object and file billing. The XaaS provider may also set a cost per IO event type, such as different rates for IO event successes and failures, or for content of different lengths.

A final example of features and advantages that may be implemented by some example embodiments concerns automated switching of metering basis based on pre-configured user preferences. Particularly, example embodiments may make it possible to automatically switch the metering basis for billing based, for example, on the type of task, or volume of tasks, that the user is undertaking. The user may pre-configure their preferences for when the switch should occur.

### E. Example Use Cases

### E.1 First Example Use Case

A user establishes a billing contract with ABC Company for services consumable in an as-a-service model, and configures admin permissions according to company privacy policies and agreements. As the user systems interact with the services exposed by the ABC Company platform, the ABC Company platform collects IO event metadata and periodically generates a bill for the user for the services consumed and interactions with the service.

The user, upon reviewing the bill, determines that she wants to understand which users or systems were generating the IO that caused a particular bill line item to be higher than expected. She is then able to double-click into the bill’s line item and see a breakdown, based on the underlying IO event metadata, of the line item by system, IP address, operation type, and resource.

The user then further decides to determine, for a given bill line item, which systems were the most active, and, which content within the service those most active systems were using. The user proceeds to write a query (relational, graph) and executes it against the underlying data, and is presented with the results indicating which systems were the most active, and which pieces of content (or aspects of the service) were most frequently used.

The user could then further decide to look deeper into the underlying IO event metadata to determine which users were using those active systems at the time to then have an educational follow-up with those users on how to adjust their activities to reduce cost.

### E.1 Second Example Use Case

A company deploys a ABC Company XaaS platform internally, and creates service accounts for various internal constituents, or business units, that will consume the services. The administrator of the as-a-service platform, after consulting with legal, adjusts the data visibility rules for billing for the engineering team in Germany. The data visibility rules are set to redact any personally-identifiable information to ensure the company remains in compliance with the regulations set forth in GDPR.

A user, such as one of the designated administrators for the German engineering team notices, an unusually high bill for a given service. The user then wants to understand which users or systems were generating the IO that caused the line item to be higher than expected. The user is then able to double-click into the bill line item and see a breakdown, based on the underlying IO event metadata, of the line item. Instead of seeing personally-identifiable information, the user is presented with unique identifiers that correlate the events, but do not disclose the identity of the service user. The user is then able to start a discussion with his engineering team to describe how the services are being used and ways in which costs can be reduced.

### F. Further Example Embodiments

Following are some further example embodiments of the invention. These are presented only by way of example and are not intended to limit the scope of the invention in any way.

Embodiment 1. A method, comprising: identifying an IO event comprising an IO made by a customer against a service hosted at an XaaS platform, and the IO event is associated with IO event metadata generated by the service; associating the IO event metadata with a billable customer operation; analyzing the IO event metadata and, based on the analyzing, associating the IO event with the customer; and generating a customer bill based on the associating of the IO event metadata with the billable customer operation, and based on the associating of the IO event with the customer.

Embodiment 2. The method as recited in embodiment 1, wherein the method is performed at the XaaS platform.

Embodiment 3. The method as recited in any of embodiments 1-2, wherein the customer bill enables the customer to identify its costs with respect to the service, on a per IO basis.

Embodiment 4. The method as recited in any of embodiments 1-3, wherein one or more billing rules determine which IO event properties are included in the customer bill and visible to the customer.

Embodiment 5. The method as recited in any of embodiments 1-4, wherein the XaaS platform enables the customer to query the IO event metadata.

Embodiment 6. The method as recited in any of embodiments 1-5, wherein the XaaS platform enables review and drill down functionality by the customer, regarding the customer bill.

Embodiment 7. The method as recited in any of embodiments 1-6, wherein the XaaS platform enables the customer to specify which IO event metadata is accessible by users, and which IO event metadata is not accessible by users.

Embodiment 8. The method as recited in any of embodiments 1-7, wherein the XaaS platform redacts some IO event metadata from the bill before sending the bill to the customer, and the redaction is performed according to one or more billing rules.

Embodiment 9. The method as recited in any of embodiments 1-8, wherein the XaaS platform enables the customer to switch, based on a task that the customer executes regarding the service, a basis on which the customer is billed.

Embodiment 10. The method as recited in any of embodiments 1-9, wherein the XaaS platform is operable to present a query and analytics interface to a user.

Embodiment 11. A method for performing any of the operations, methods, or processes, or any portion of any of these, disclosed herein.

Embodiment 12. A computer readable storage medium having stored therein instructions that are executable by one or more hardware processors to perform operations comprising the operations of any one or more of embodiments 1-11.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

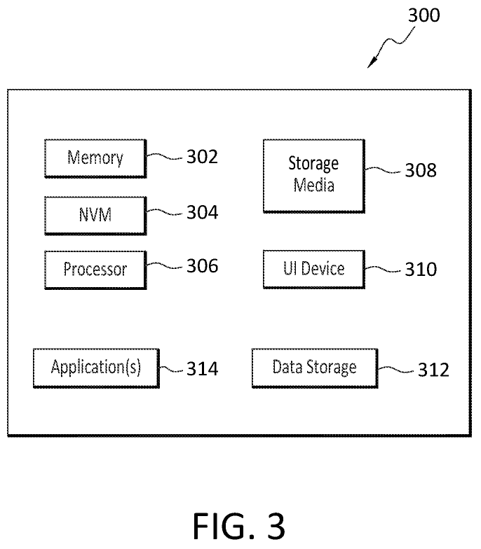

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
identifying an IO event comprising an IO made by a customer against a service hosted at an XaaS platform, and the IO event is associated with IO event metadata generated by the service;
associating the IO event metadata with a billable customer operation;
analyzing the IO event metadata and, based on the analyzing, associating the IO event with the customer; and
generating a customer bill based on the associating of the IO event metadata with the billable customer operation, and based on the associating of the IO event with the customer.

2. The method as recited in claim 1, wherein the method is performed at the XaaS platform.

3. The method as recited in claim 1, wherein the customer bill enables the customer to identify its costs with respect to the service, on a per IO basis.

4. The method as recited in claim 1, wherein one or more billing rules determine which IO event properties are included in the customer bill and visible to the customer.

5. The method as recited in claim 1, wherein the XaaS platform enables the customer to query the IO event metadata.

6. The method as recited in claim 1, wherein the XaaS platform enables review and drill down functionality by the customer, regarding the customer bill.

7. The method as recited in claim 1, wherein the XaaS platform enables the customer to specify which IO event metadata is accessible by users, and which IO event metadata is not accessible by users.

8. The method as recited in claim 1, wherein the XaaS platform redacts some IO event metadata from the bill before sending the bill to the customer, and the redaction is performed according to one or more billing rules.

9. The method as recited in claim 1, wherein the XaaS platform enables the customer to switch, based on a task that the customer executes regarding the service, a basis on which the customer is billed.

10. The method as recited in claim 1, wherein the XaaS platform is operable to present a query and analytics interface to a user.

11. A computer readable storage medium having stored therein instructions that are executable by one or more hardware processors to perform operations comprising:
identifying an IO event comprising an IO made by a customer against a service hosted at an XaaS platform, and the IO event is associated with IO event metadata generated by the service;
associating the IO event metadata with a billable customer operation;
analyzing the IO event metadata and, based on the analyzing, associating the IO event with the customer; and
generating a customer bill based on the associating of the IO event metadata with the billable customer operation, and based on the associating of the IO event with the customer.

12. The computer readable storage medium as recited in claim 11, wherein the computer readable storage medium is performed at the XaaS platform.

13. The computer readable storage medium as recited in claim 11, wherein the customer bill enables the customer to identify its costs with respect to the service, on a per IO basis.

14. The computer readable storage medium as recited in claim 11, wherein one or more billing rules determine which IO event properties are included in the customer bill and visible to the customer.

15. The computer readable storage medium as recited in claim 11, wherein the XaaS platform enables the customer to query the IO event metadata.

16. The computer readable storage medium as recited in claim 11, wherein the XaaS platform enables review and drill down functionality by the customer, regarding the customer bill.

17. The computer readable storage medium as recited in claim 11, wherein the XaaS platform enables the customer to specify which IO event metadata is accessible by users, and which IO event metadata is not accessible by users.

18. The computer readable storage medium as recited in claim 11, wherein the XaaS platform redacts some IO event metadata from the bill before sending the bill to the customer, and the redaction is performed according to one or more billing rules.

19. The computer readable storage medium as recited in claim 11, wherein the XaaS platform enables the customer to switch, based on a task that the customer executes regarding the service, a basis on which the customer is billed.

20. The computer readable storage medium as recited in claim 11, wherein the XaaS platform is operable to present a query and analytics interface to a user.
